(19) United States
(12) Patent Application Publication
(10) Pub. No.: US 2024/0201941 A1
(43) Pub. Date: Jun. 20, 2024

(54) ACOUSTIC DEVICE, ACOUSTIC DEVICE CONTROL METHOD, AND PROGRAM

(71) Applicant: AlphaTheta Corporation, Yokohama-shi, Kanagawa (JP)

(72) Inventor: Minoru Watanabe, Yokohama-shi, Kanagawa (JP)

(21) Appl. No.: 18/557,336

(22) PCT Filed: Apr. 30, 2021
(86) PCT No.: PCT/JP2021/017188

§ 371 Date: Oct. 26, 2023

(51) Int. Cl. G06F 3/16; G10H 1/00

(52) U.S. Cl. CPC G06F 3/165; G10H 1/0008; G10H 2210/076; G10H 2210/391

(57) ABSTRACT

An acoustic device for mixing at least two music pieces including first and second music pieces is provided, the acoustic device including: a detector for detecting tempos of the first and second music pieces each including a plurality of parts including a first part; and a playback controller for gradually changing a tempo of the first part of the first music piece or the second music piece and synchronizing the tempo of the first part of the first music piece and the tempo of the first part of the second music piece at a mixing start time or after an elapse of a predetermined time from the mixing start time.

### TECHNICAL FIELD

The present invention relates to an acoustic device, a control method of the acoustic device, and a program.

### BACKGROUND ART

Typical DJ instruments (e.g. DJ controllers), which each include a plurality of decks, are configured to switch the currently played music piece to another music piece by switching sound outputs of the decks while playing music with the plurality of decks. In order to switch the music pieces by the DJ instruments, a cross fader, which is configured to adjust sound volumes of the plurality of decks provided on the DJ instruments, is used. However, the cross fader requires a skillful operation by a user for natural switching operation.

Thus, various techniques for supporting the music switching operation have been proposed. For instance, an acoustic device disclosed in Patent Literature 1 adjusts an output level, focusing on a frequency range, thereby preventing occurrence of uncomfortable impression when the music pieces are mixed.

### CITATION LIST

### Patent Literature(s)

Patent Literature 1: JP Patent No. 6171503

### SUMMARY OF THE INVENTION

### Problem(s) to be Solved by the Invention

At the time of the above-described switching operation of music pieces, if the tempos of the music pieces before and after the switching operation are not aligned, the continuity of BPM is lost to make an uncomfortable and unpleasant impression on a user. Further, when the BPM is changed in order to align the tempos of the music pieces before and after the switching operation, divergence between an original music and playback sound becomes eminent (especially for melody line), thereby making uncomfortable and unpleasant impression on a user.

An object of the invention is to provide an acoustic device, a control method of the acoustic device, and a program that allow a user to perform a suitable switching operation during a mixing process for switching music pieces without making uncomfortable and unpleasant impression on a user.

### Means for Solving the Problem(s)

[1] An acoustic device for mixing at least two music pieces including a first music piece and a second music piece, the acoustic device includes: a detector configured to detect a tempo of the first music piece and a tempo of the second music piece, the first and second music pieces each including a plurality of parts including a first part; and a playback controller configured to gradually change a tempo of the first part of the first music piece or the second music piece and synchronize the tempo of the first part of the first music piece and the tempo of the first part of the second music piece at a mixing start time or after an elapse of a predetermined time from the mixing start time.

[2] An acoustic device for mixing at least two music pieces including a first music piece and a second music piece, the acoustic device includes: a detector configured to detect a tempo of the first music piece and a tempo of the second music piece, the first and second music pieces each including a plurality of parts including a first part; and a playback controller configured to gradually change a tempo of the first part of the first music piece and a tempo of the first part of the second music piece and synchronize the tempo of the first part of the first music piece and the tempo of the first part of the second music piece at a mixing start time or after an elapse of a predetermined time from the mixing start time.

[3] The acoustic device according to [1] or [2], in which the playback controller is configured to gradually shift the tempo of the first part of the first music piece or the second music piece to an original tempo thereof after synchronizing the tempos of the respective first parts of the first and second music pieces.

[4] The acoustic device according to any one of claims [1] to [3], in which the playback controller is configured to align a playback position of the first part of the first music piece or the second music piece with a playback position of a second part different from the first part of the first music piece or the second music piece after gradually shifting the tempo of the first part of the first music piece or the second music piece to an original tempo of the first music piece or the second music piece.

[5] The acoustic device according to any one of [1] to [4] further includes a cross fader, in which the playback controller is configured to determine a time when the cross fader starts moving from one end toward the other end thereof as the mixing start time.

[6] The acoustic device according to any one of [1] to [5], in which in a predetermined section including the mixing start time or a point after an elapse of a predetermined time from the mixing start time, the playback controller is configured to play a second part of the first music piece at an original tempo of the first music piece, play a second part of the second music piece at an original tempo of the second music piece, and switch the second part of the first music piece to the second part of the second music piece.

[7] The acoustic device according to any one of [1] to [6], in which the first part is a part at least corresponding to a bass drum sound a drum sound.

[8] A control method of an acoustic device for mixing at least two music pieces including a first music piece and a second music piece, the method includes: detecting a tempo of the first music piece and a tempo of the second music piece, the first and second music pieces each including a plurality of parts including a first part; gradually changing a tempo of the first part of the first music piece or the second music piece; and synchronizing the tempo of the first part of the first music piece and the tempo of the first part of the second music piece at a mixing start time or after an elapse of a predetermined time from the mixing start time.

[9] A control method of an acoustic device for mixing at least two music pieces including a first music piece and a second music piece, the method includes: detecting a tempo of the first music piece and a tempo of the second music piece, the first and second music pieces each including a plurality of parts including a first part; gradually changing a tempo of the first part of the first music piece and the tempo of the first part of the second music piece; and synchronizing the tempo of the first part of the first music piece and the tempo of the first part of the second music piece at a mixing start time or after an elapse of a predetermined time from the mixing start time.

[10] A program causing a computer to operate as an acoustic device for mixing at least two music pieces including a first music piece and a second music piece, the acoustic device including: a detector configured to detect a tempo of the first music piece and a tempo of the second music piece, the first and second music pieces each including a plurality of parts including a first part; and a playback controller configured to gradually change a tempo of the first part of the first music piece or the second music piece and synchronize the tempo of the first part of the first music piece and the tempo of the first part of the second music piece at a mixing start time or after an elapse of a predetermined time from the mixing start time.

[11] A program causing a computer to operate as an acoustic device for mixing at least two music pieces including a first music piece and a second music piece, the acoustic device including: a detector configured to detect a tempo of the first music piece and a tempo of the second music piece, the first and second music pieces each including a plurality of parts including a first part; a playback controller configured to gradually change a tempo of the first part of the first music piece and a tempo of the first part of the second music piece and synchronize the tempo of the first part of the first music piece and the tempo of the first part of the second music piece at a mixing start time or after an elapse of a predetermined time from the mixing start time.

### BRIEF DESCRIPTION OF THE DRAWINGS

FIG. 1 is an illustration schematically depicting an acoustic device according to a first exemplary embodiment of the invention.

FIG. 2 is a block diagram illustrating an overall functional arrangement of the acoustic device according to the first exemplary embodiment of the invention.

FIG. 3 is an illustration schematically showing a switching process of music pieces according to the first exemplary embodiment of the invention.

FIG. 4 is another illustration schematically showing the switching process of music pieces according to the first exemplary embodiment of the invention.

FIG. 5 is still another illustration schematically showing the switching process of music pieces according to the first exemplary embodiment of the invention.

FIG. 6 is a flowchart showing a control method of the acoustic device according to the first exemplary embodiment of the invention.

FIG. 7 is another flowchart showing a control method of the acoustic device according to the first exemplary embodiment of the invention.

FIG. 8 is an illustration schematically showing a switching process of music pieces according to a second exemplary embodiment of the invention.

FIG. 9 is a flowchart showing a control method of the acoustic device according to the second exemplary embodiment of the invention.

FIG. 10 is an illustration schematically showing a switching process of music pieces according to a third exemplary embodiment of the invention.

FIG. 11 is a flowchart showing a control method of the acoustic device according to the third exemplary embodiment of the invention.

### DESCRIPTION OF EMBODIMENT(S)

Some exemplary embodiments of the invention will be described in detail below with reference to the attached drawings. It should be noted that components of the same or substantially the same function(s) and structure(s) will be denoted by the same reference numerals in the specification and drawings, omitting repetition of description thereof.

### First Exemplary Embodiment

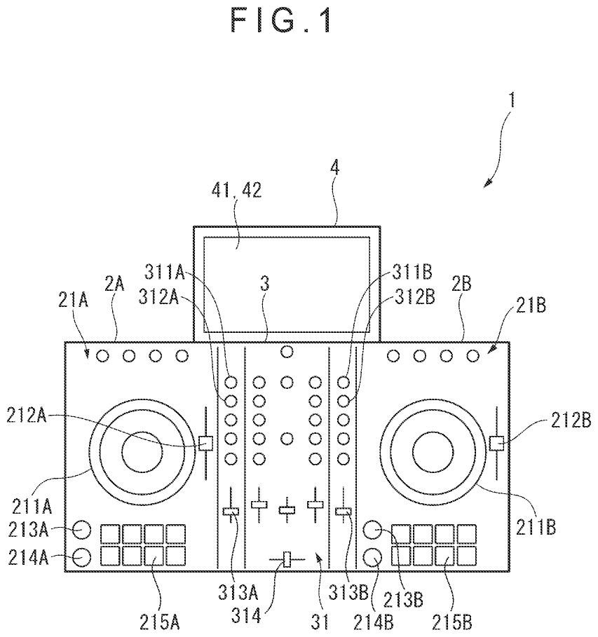

FIG. 1 is an illustration schematically depicting an acoustic device according to a first exemplary embodiment of the invention.

An acoustic device 1 according to the first exemplary embodiment is a DJ system including two media players 2A and 2B, which are each configured to play a music piece, a mixer 3 configured to control the media players 2A and 2B, and a display unit 4, the media players 2A and 2B, the mixer 3, and the display unit 4 being integrated to form a unitary system. Specifically, the acoustic device 1, which serves as a sound playback device and a sound playback control device in response to an operation by a user, is configured to play the music piece and apply various effects on currently played music piece. Examples of the effects include effects for outputting an effected sound by applying an effect (e.g. delay, echo, reverb, or loop) on a music piece and effects for outputting a processed sound by processing an original sound.

As shown in FIG. 1, the acoustic device 1 includes operation units 21A and 21B respectively provided on the media players 2A and 2B, and an operation unit 31 provided on the mixer 3.

The operation unit 21A and the operation unit 21B are configured to receive user's operations on the media player 2A and the media player 2B, respectively. The operation unit 31 is configured to receive a user's operation on the mixer 3.

The operation unit 21A includes a jog dial 211A, a tempo slider 212A, a cue button 213A, a play/pause button 214A, and a performance pad 215A.

More specifically, the jog dial 211A is a rotary operator and is used for setting a playback direction and playback speed of the music piece currently played by the media player 2A. The tempo slider 212A is used in order to control the playback speed of the music piece currently played by the media player 2A. The cue button 213A is pressed down for setting a predetermined point of the music piece as a cue point. The play/pause button 214A is pressed down for starting or stopping playing the music piece with the media player 2A. The performance pad 215A is a versatile operator capable of being assigned with various functions relating to the playback control.

The operation unit 21B includes, as with the operation unit 21A, a jog dial 211B, a tempo slider 212B, a cue button 213B, a play/pause button 214B, and a performance pad 215B.

The acoustic device 1 is configured to, for instance, in response to a user's operation on the operation unit 21A of the media player 2A, play the music piece loaded to the media player 2A and apply an effect(s) on the music piece being played as necessary. The same applies to the media player 2B.

The mixer 3 is configured to, in accordance with a user's operation, switch the music pieces between those being played by the media players 2A and 2B, adjust a sound volume of each of the channels, and apply the effect(s) on the music piece(s) being played.

The operation unit 31 of the mixer 3 includes effect selector knobs 311A and 311B, effect amount adjuster knobs 312A and 312B, channel faders 313A and 313B, and a cross fader 314.

More specifically, the effect selector knobs 311A and 311B are used in order to select the effect(s) to be applied on the music piece being played by the media players 2A and 2B, respectively. The effect amount adjuster knobs 312A and 312B are used in adjusting parameters (e.g. depth, magnitude) of the effects applied on the music pieces being played by the media players 2A and 2B, respectively. The channel faders 313A and 313B are used in adjusting output sound volume levels of the music pieces being played by the media players 2A and 2B, respectively.

The cross fader 314 is an operator for adjusting a sound volume balance between a first music piece played by the media player 2A (first channel) and a second music piece played by the media player 2B (second channel).

The display unit 4 includes a display 41 and a touch panel 42 provided in a manner to cover a display area of the display. The display unit 4, which is provided with the touch panel 42 configured to detect the position touched by a user and output information such as coordinates indicating the touch position, also serves as an operation unit.

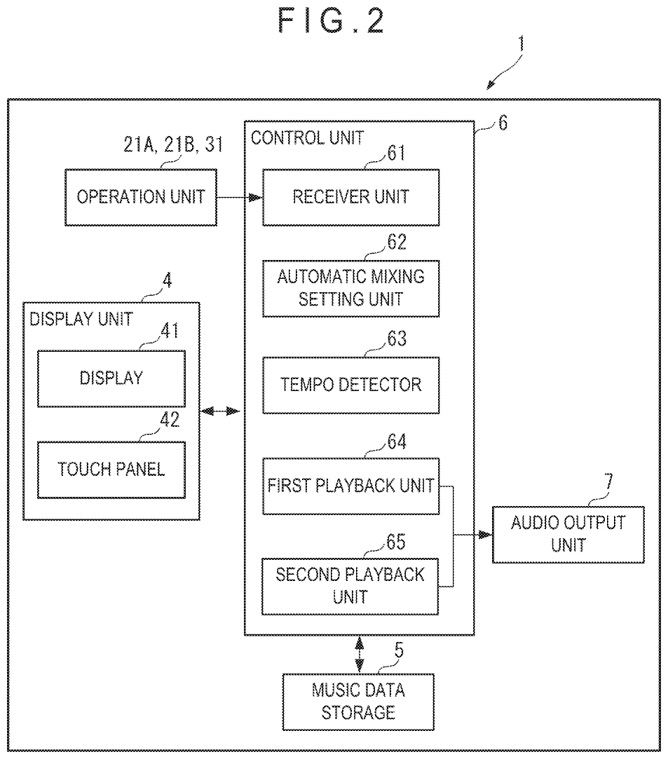

FIG. 2 is a block diagram showing an overall functional arrangement of a processing unit of the acoustic device according to the first exemplary embodiment.

As shown in FIG. 2, the acoustic device 1 includes a music data storage 5, a control unit 6, and an audio output unit 7 in addition to the above-described units. The functions of the above units are implemented by, for instance, arranging the acoustic device configured as a computer hardware and operating a processor of the acoustic device in accordance with a computer program. The functions of the above units will be further described below.

The music data storage 5, which is provided by an HDD (Hard Disk Drive), flash memory, or the like, is capable of storing music data. Specifically, the music data storage 5 stores music data of a plurality of music pieces in a predetermined format (e.g. MP3 format). The music data includes, in addition to audio information, information on BPM, art work, title, artist name, album title, key, the number of DJ performance, genre, and the like of the music pieces in a form of tag information. The music data stored in the music data storage 5 is associated with a time stamp representing information on playback position.

In the present exemplary embodiment, the music data stored in the music data storage 5 in a manner capable of being played by the acoustic device 1 has been subjected in advance to a part-separation processing into a plurality of parts. In the present exemplary embodiment, the plurality of parts separated from the music data each correspond to the sound of corresponding one of the parts of the music piece to be played based on the music data. The parts of the music piece herein correspond to a vocal sound or sounds of various musical instruments. In a simple example, the music piece is constructed by four parts of the vocal, guitar, bass guitar, and drum. It is also useful to subdivide the parts into minor categories (sub-parts) per type of the musical instruments: for instance, the drum part is subdivided into bass drum part, snare drum part, and hi-hat drum part. It should be noted that detailed description of the part-separation processing into the plurality of parts will be omitted herein since the part-separation processing can be performed using various known techniques.

In an example described below, it is supposed that the music data having been subjected to the part-separation processing to be separated into two parts (the drum sound part and parts of musical instruments other than drum and/or vocal part) is stored in the music data storage 5. It should also be noted that the acoustic device 1 is optionally configured to acquire the music data having been subjected to the part-separation processing from an external device or, alternatively, is further provided with a functional component for separating non-separated music data into the plurality of parts.

The control unit 6, which is implemented in the acoustic device 1 in a form of, for instance, a communication interface, a processor (e.g. CPU (Central Processing Unit)), and a memory providing a working area, controls the operation of the acoustic device 1. The control unit 6 includes a receiver unit 61, an automatic mixing setting unit 62, a tempo detector 63, a first playback unit 64, and a second playback unit 65, which are implemented by the processor that works in accordance with a program stored in the memory or received through the communication interface.

The receiver unit 61 is configured to receive user's operations on the operation units 21A, 21B, the operation unit 31, and the touch panel 42.

The automatic mixing setting unit 62 is configured to determine a setting for an automatic mixing process for automatically switching the music pieces (mixing) in accordance with the user's operation on the operation units 21A, 21B, the operation unit 31, and the touch panel 42.

The setting for the automatic mixing process is determined by designating the switching results of the music pieces. The switching results of the music piece include, for instance, a timing for switching the music pieces by fade-in and fade-out, a time after the music piece after the switching by fade-out and fade-in starts being heard until the music piece before the switching by fade-out and fade-in is not heard, a sound volume of each of the music pieces at a midpoint (where the sound volume becomes even) of fade-out and fade-in, and a time from the cut-in of the music piece after the switching to the cut-out of the music piece before the switching.

In determining the setting for the automatic mixing process, the music pieces can be switched in accordance with the characteristics of the target music data by designating the above-described switching results on the music data (a target of switching operation) in association with cue point(s) or the like. Such a detailed setting is made before DJ performance using, for instance, the display 41 and the touch panel 42 of the acoustic device 1 or a computer connected to the acoustic device 1. Details of the setting by the automatic mixing setting unit 62 will be described together with later-described automatic mixing process.

The tempo detector 63 is configured to detect tempos of the first music piece and second music piece.

The first playback unit 64 is configured to play the music piece with the media player 2A in response to the user's operation on the operation unit 21A and operation unit 31 and to output audio signals to the audio output unit 7. Similarly, the second playback unit 65 is configured to play the music piece with the media player 2B in response to the user's operation on the operation unit 21B and operation unit 31 and to output audio signals to the audio output unit 7. When the setting for the automatic mixing process is done by the automatic mixing setting unit 62 and an instruction for performing the automatic mixing process is made by the user's operation on the operation units 21A, 21B and the operation unit 31, the first playback unit 64 and the second playback unit 65 adjust a sound volume balance between the first and second music pieces, and the like, for each of a plurality of parts in accordance with the setting by the automatic mixing setting unit 62 to switch the music pieces between the media player 2A and the media player 2B.

It should be noted that the acoustic device 1 optionally includes a communication interface (not illustrated), through which music data stored in an external storage, a computer, or the like is imported and stored in the music data storage 5. In this case, the acoustic device 1 does not include the music data storage 5 but the external storage serves as the music data storage 5.

The audio output unit 7, which includes an audio output terminal such as speaker terminal or headphone terminal, outputs audio signals (audio information) of the music pieces have been played by the first playback unit 64 and the second playback unit 65.

Operations of the control unit 6 of the above-described acoustic device 1 when the music pieces are switched in the automatic mixing process will be described below.

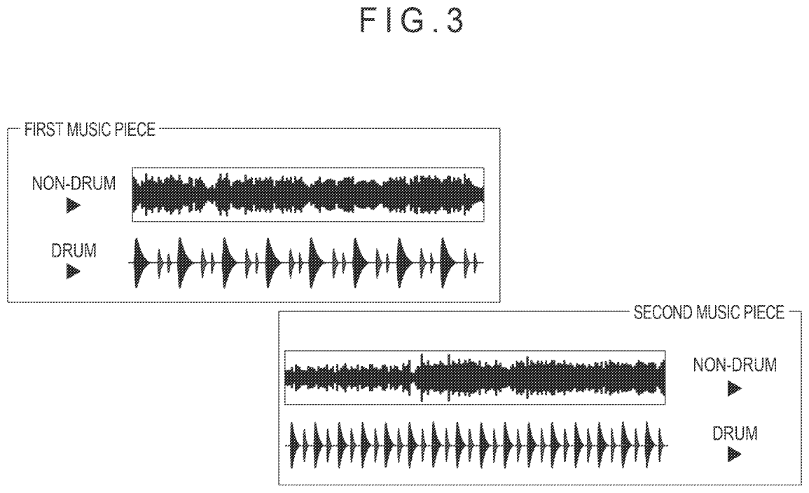

FIG. 3 illustrates an example of a first music data (the first music piece) and a second music data (the second music piece) at a section for the music pieces to be switched by the acoustic device according to the first exemplary embodiment. In the example of FIG. 3, the music data for the first and second music pieces are different in tempo. The “tempo” herein refers to a beat defined by BPM, beat position, or the like.

In a typical arrangement for switching the music pieces, an entirety of the music pieces are uniformly switched. Accordingly, when, for instance, the tempos (BPM) of the first and second music pieces are different in switching the music pieces and the first and second music pieces are mixed at the original tempos, continuity of BPM is lost to make uncomfortable and unpleasant impression on a user. Such a problem becomes especially eminent for the drum sound in switching the music pieces.

Further, when the tempo (BPM) of one or both of the music pieces is changed in order to synchronize the tempo (BPM), divergence between an original music and playback sound becomes eminent (especially for melody line), thereby making uncomfortable and unpleasant impression on a user.

Thus, the acoustic device 1 of the first exemplary embodiment is configured to perform a switching process for mixing operation for each of a plurality of parts of the music pieces in accordance with the characteristics of each of the parts.

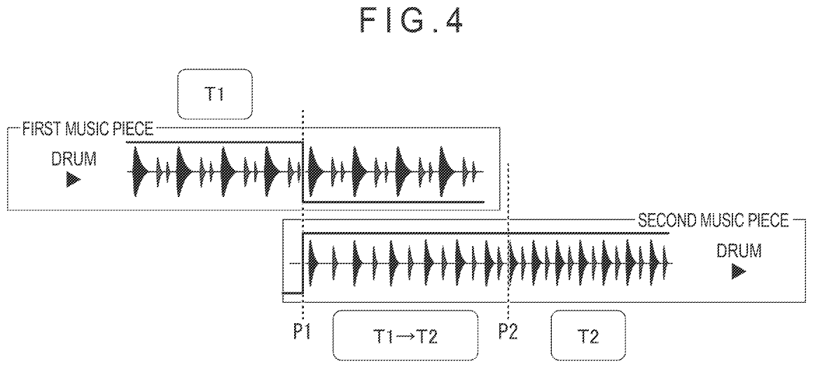

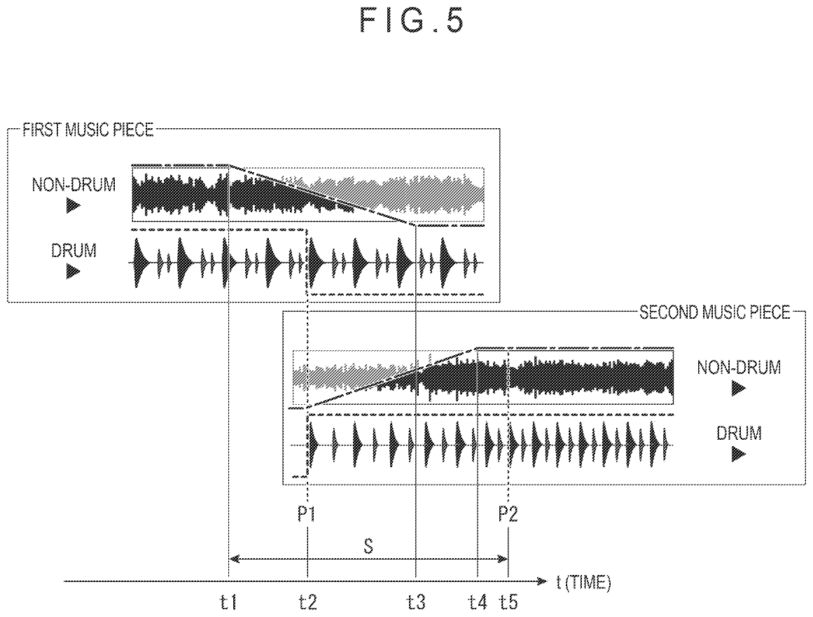

FIGS. 4 and 5 are illustrations schematically explaining the switching process of the music pieces by the acoustic device according to the first exemplary embodiment. In an example described below, it is exemplarily assumed that the music piece played by the media player 2A is switched to the music piece played by the media player 2B. Further, an original tempo of the first music piece and an original tempo of the second music piece will be referred to as a tempo T1 and a tempo T2, respectively.

Initially, the process for the drum sound part will be described below with reference to FIG. 4. The acoustic device 1 performs the mixing process of the drum sound parts through the following steps (1) to (3) as shown in FIG. 4.
(1) At a first time point P1, the tempo of the drum sound part of the second music piece is changed, thereby synchronizing the tempos of the drum sound parts of the first and second music pieces, and the first music piece is cut out and the second music piece is cut in. Thus the first music piece is switched to the second music piece.
(2) During a period from the first time point P1 to a second time point P2, the tempo of the drum sound part of the second music piece is gradually changed.
(3) At the second time point P2, the playback positions of the drum sound part and the non-drum sound part of the second music piece are aligned.

The process including the steps of (1) to (3) is for switching the music pieces in accordance with the characteristics of the drum sound part while restraining uncomfortable and unpleasant impression caused at the time of the mixing operation. The drum sound part has a large sound volume level, different patterns for each of music pieces, and different delays for each of music pieces from attack sounds to peak sounds (especially for the bass drum). Accordingly, when the drum sound parts of the music pieces are switched without synchronizing the tempos, it sometimes occurs that uncomfortable and unpleasant impression is made on a user as described above.

Thus, for the drum sound part, the tempos of the drum sound parts of the first and second music pieces are synchronized in being switched as described in (1). Since the drum sound part has no melody and lyrics, continuity of the drum sound is unlikely to be perceived by listeners. Accordingly, the drum sound parts of music pieces are switched by cut-out and cut-in to further restrain the uncomfortable impression in switching the music pieces.

Subsequently, as described in (2), the tempo is gradually changed to the tempo T2 during the period from the first time point P1 to the second time point P2. Then, as described in (3), the playback positions of the drum sound part and the non-drum sound part of the second music piece are aligned at the second time point P2.

Through the above steps, the tempo of the drum sound part of the second music piece is synchronized with the tempo T1 (i.e. the original tempo of the drum sound part of the first music piece) at the first time point P1, thereby switching the music pieces without causing uncomfortable impression. Subsequently, the tempo of the drum sound part of the second music piece is gradually changed from the tempo T1 to the tempo T2 (i.e. the original tempo of the second music piece) during the period from the first time point P1 to the second time point P2, and the playback positions of the drum sound part and the non-drum sound part of the second music piece are aligned at the second time point P2. Then, the drum sound part and the non-drum sound part of the second music piece are played at the tempo T2 after the second time point P2. In other words, the playback sound of the second music piece becomes a normal playback sound whose tempo or the like is not modified, at or after the second time point.

In order to perform the process of steps (1) to (3), the automatic mixing setting unit 62 determines, for instance, the following setting for the drum sound part.

First music piece: cut-out position (P1)

Second music piece: cut-in position (P1), point for aligning the playback positions of the drum sound part and the non-drum sound part (P2)

It should be noted that the cut-out position (P1) of the drum sound part of the first music piece and the cut-in position (P1) of the drum sound part of the second music piece are optionally automatically set. For instance, the timing suitable for the cut-out and cut-in of the drum sound part of the first and second music pieces is optionally determined and set through known music analysis technique (e.g. beat position detection, bar position detection, vocal detection, and lyrics display).

The first playback unit 64 and the second playback unit 65 respectively play the drum sound parts of the first and second music pieces as follows in accordance with the setting by the automatic mixing setting unit 62.

Until the first time point P1: the first music piece is played at the tempo T1.

At the first time point P1: the first music piece is made to cut out and the second music piece is played at the tempo T1.

During a period from the first time point P1 to the second time point P2: the tempo of the second music piece is gradually changed from the tempo T1 to the tempo T2.

At or after the second time point P2: the second music piece is played at the tempo T2.

Next, the process for the non-drum sound part will be described below with reference to FIG. 5. Continuity of the non-drum sound part is likely to be perceived by listeners due to the presence of melody and lyrics. Accordingly, when the tempo is changed in switching the music pieces, divergence between the original music and the playback sound increases, sometimes making an uncomfortable and unpleasant impression on a user. Accordingly, for the non-drum sound part, the acoustic device 1 switches the first music piece to the second music piece in a mixing section S including the first time point P1 without changing the tempo as shown in FIG. 5.

By switching the music pieces as described above, the melody and lyrics can be kept from being fast (or slow) forwarded due to the adjustment of the tempo of the non-drum sound part, thereby preventing uncomfortable and unpleasant impression from being made on a user.

For the non-drum sound part, the automatic mixing setting unit 62 sets, for instance, a start point and an end point of the fade-out of the first music piece and a start point and an end point of the fade-in of the second music piece. At this time, the mixing section S preferably includes the above-described cut-in and cut-out positions of the drum sound part. The mixing section S defined as described above allows the non-drum sound part to be naturally switched in a background process of the switching operation for the drum sound parts of the music pieces by cut-out and cut-in.

It should be noted that the start and end points of fade-out or fade-in of the non-drum sound parts of the first and second music pieces are optionally automatically set. For instance, the timing suitable for starting or ending the fade-out or fade-in of the non-drum sound part of the first and second music pieces is optionally determined and set through known music analysis technique (e.g. key detection, music development detection, vocal detection, and lyrics display).

The first playback unit 64 and the second playback unit 65 respectively play the non-drum sound parts of the first and second music pieces as follows in accordance with the setting by the automatic mixing setting unit 62.

Until the fade-out start point of the first music piece (i.e. mixing start time): play the first music piece at the tempo T1 (i.e. the original tempo of the first music piece).

From the fade-out start point to the fade-out end point of the first music piece: fade out the first music piece.

From the fade-in start point to the fade-in end point of the second music piece (after an elapse of a predetermined time from the mixing start time): play (fade in) the second music piece at the tempo T2 (i.e. the original tempo of the second music piece).

After the fade-in end point of the second music piece: play the second music piece at the tempo T2 (i.e. the original tempo of the second music piece).

As described above, when the automatic mixing process is started, the first playback unit 64 gradually reduces the sound volume of the non-drum sound part of the first music piece and starts fade-out at a time t1. At a time t2, the drum sound part of the first music piece is made to cut out by the first playback unit 64. Meanwhile, the second playback unit 65 gradually increases the sound volume of the non-drum sound part of the second music piece to start fade-in, make the drum sound part of the second music piece cut in at the tempo T1 (the original tempo of the first music piece), and gradually changes the tempo of the drum sound part of the second music piece to the tempo T2.

At a time t3, the first playback unit 64 ends fade-out of the non-drum sound part of the first music piece. At a time t4, the second playback unit 65 ends fade-in of the non-drum sound part of the second music piece. Then, at a time t5, the playback positions of the drum sound part and the non-drum sound part of the second music piece are aligned.

In other words, the drum sound parts of the music pieces are switched at the first time point P1 by cut-out and cut-in with the tempos of the music pieces being adjusted, whereas the non-drum sound parts of the music pieces are switched by fade-out and fade-in without changing the tempos of the music pieces. Then, at the second time point P2, the playback positions of the drum sound part and the non-drum sound part of the second music piece are aligned. Accordingly, each of the plurality of parts of the music piece is switched through a process in accordance with the characteristics of each part, whereby a favorable switching is achievable.

It should be noted that, though the tempo of the drum sound part of the second music piece is gradually changed from the time t2 to the time t5, the tempo of the non-drum sound part is not changed. Accordingly, there is a gap in tempo and the playback positions between the drum sound part and the non-drum sound part of the second music piece during the period from the time t2 to the time t5. The gap is maximized at the time t2 and becomes substantially zero at the time t5. However, the non-drum sound part, whose sound volume is small as compared with the drum sound part and whose rhythm is less noticeable as long as the drum sound part (main part for beating the rhythm) is stably played, is less affected by the above-described gap.

It is possible that the music data having been subjected to the part-separation processing is used only in the mixing section S (from the time t1 to the time t5) and non-separated music data is used in other sections. In this case, the first playback unit 64 plays the non-separated first music data until the time t1 and then plays the first music data being subjected to the part-separation processing from the time t1. Meanwhile, the second playback unit 65 plays the second music data being subjected to the part-separation processing from the time t2 and then plays the non-separated second music data from the time t5.

It should be noted that the switching process of the music pieces shown in the example of FIG. 5 is merely exemplary and are not exhaustive. For instance, the non-drum sound parts of the music pieces, which are switched by fade-out and fade-in in the example of FIG. 5, are optionally switched by cut-out and cut-in or, alternatively, are optionally switched in combination of fade-out/in and cut-out/in. Further, the drum sound parts of the music pieces, which are switched by cut-out and cut-in in the example of FIG. 5, are optionally switched by fade-out and fade-in or, alternatively, are optionally switched in combination of fade-out/in and cut-out/in. Further, either of the parts may be made to cut out and cut in at the same time or alternatively to cut out and cut in at different timings.

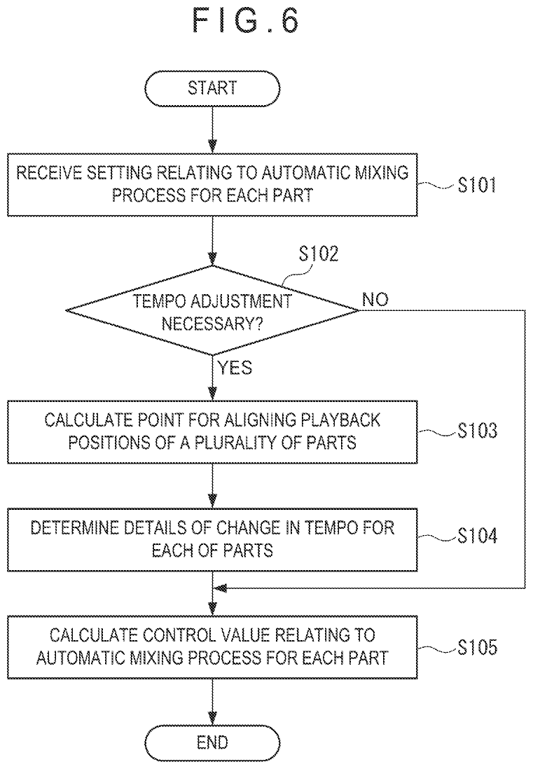

Next, a control method of the acoustic device in determining the setting for the automatic mixing process according to the first exemplary embodiment of the invention will be described below with reference to a flowchart illustrated in FIG. 6.

FIG. 6 illustrates a flowchart of a process started when the receiver unit 61 receives an operation for instructing the setting for the automatic mixing process.

The automatic mixing setting unit 62 receives the setting for each of the plurality of parts of the first and second music pieces (Step S101).

Then, the automatic mixing setting unit 62 judges whether it is necessary to adjust the tempo (Step S102). The necessity for adjusting the tempo can be judged by determining whether the tempo (BPM) of the first music piece is the same as the tempo of the second music piece. For instance, when the tempos (BPM) of the first and second music pieces are different as in the example shown in FIG. 5, the automatic mixing setting unit 62 judges that the tempo adjustment is necessary.

When it is judged that the tempo adjustment is necessary (Step S102: YES), the automatic mixing setting unit 62 calculates the time point for aligning the playback positions of the plurality of parts (Step S103). The time point (the second time point P2) for aligning the playback positions of the plurality of parts may be, for instance, a time point after an elapse of a predetermined time from cut-in of the drum sound part of the second music piece (the first time point P1) or a time point after an elapse of a predetermined time from the end of fade-in of the non-drum sound part of the second music piece. Alternatively, the time point for aligning the playback positions of the plurality of parts is optionally calculated based on known music analysis processing (e.g. key detection, music piece development detection, vocal detection, and lyrics display).

Next, the automatic mixing setting unit 62 determines details of the change in tempo based on the time point for aligning the playback positions of the plurality of parts calculated in Step S103 (Step S104). The details of the change in the tempo can be determined based on the tempos of the first and second music pieces and the time point for aligning the playback positions of the plurality of parts. For instance, in the example described with reference to FIG. 5, the details for changing the tempo of the drum sound part of the second music piece from the tempo T1 (i.e. the original tempo of the first music piece) to the tempo T2 (i.e. the original tempo of the second music piece) during the period from the cut-in time point of the drum sound part of the second music piece (the first time point P1) to the time point for aligning the playback positions of the plurality of parts (the second time point P2) are determined.

Then, the automatic mixing setting unit 62 calculates a control value for the automatic mixing process for each of the plurality of parts in accordance with the setting received by the automatic mixing setting unit 62 (Step S105). When judging in Step S102 that the tempo adjustment is necessary, the automatic mixing setting unit 62 calculates the control value in view of the process in Steps S103 and S104. In contrast, when judging in Step S102 that the tempo adjustment is unnecessary, the automatic mixing setting unit 62 calculates the control value based on the received details of the setting. Detailed description of the calculation of the control value will be omitted herein since the control value can be calculated using various known techniques.

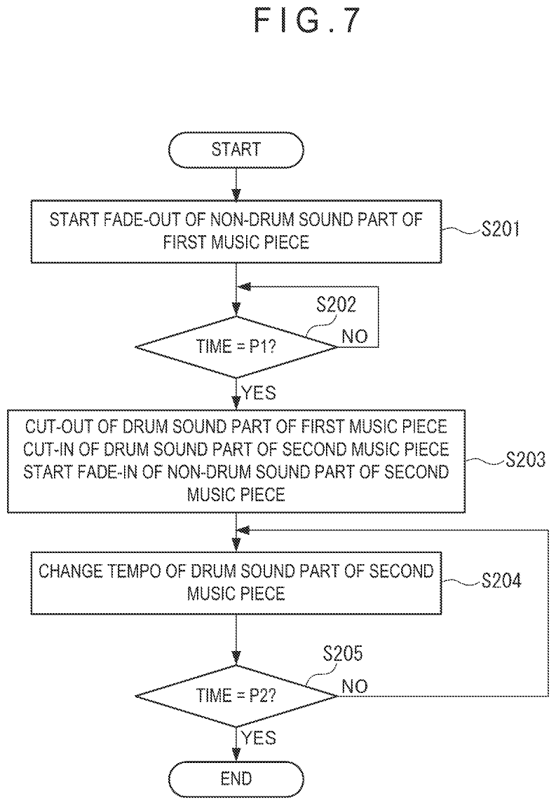

Next, a control method of the acoustic device in performing the automatic mixing process according to the first exemplary embodiment of the invention will be described below with reference to a flowchart illustrated in FIG. 7.

FIG. 7 illustrates a flowchart of a process started when the receiver unit 61 receives an operation instructing that the automatic mixing process should be performed.

The first playback unit 64 starts fade-out of the non-drum sound part of the first music piece in accordance with the control value calculated by the automatic mixing setting unit 62 (Step S201).

At the first time point P1 for the drum sound parts of the first and second music pieces to be respectively made to cut out and cut in (Step S202: YES), the drum sound part of the first music piece is made to cut out by the first playback unit 64 in accordance with the control value calculated by the automatic mixing setting unit 62. Meanwhile, the drum sound part of the second music piece is made to cut in by the second playback unit 65 in accordance with the control value calculated by the automatic mixing setting unit 62 at the tempo T1 (the original tempo of the first music piece) and starts fade-in of the non-drum sound part of the second music piece (Step S203). Subsequently, the second playback unit 65 gradually changes the tempo of the drum sound part of the second music piece to the tempo T2 (the original tempo of the second music piece) in accordance with the control value calculated by the automatic mixing setting unit 62 (Step S204).

Then, the second playback unit 65 continues the process of Step S204 until the time point P2, where the playback positions of the drum sound part and the non-drum sound part of the second music piece are aligned (Step S205: YES).

It should be noted that, though the music pieces are switched from the media player 2A to the media player 2B in the example of FIGS. 3 to 7, the same process is performed in switching the music piece played by the media player 2B to the music piece played by the media player 2A. Further, though the tempo T1 of the first music piece is slower than the tempo T2 of the second music piece in the example of FIGS. 3 to 5, the same process is applicable to an instance where the tempo T1 of the first music piece is faster than the tempo T2 of the second music piece.

The processes performed in the above-described first exemplary embodiment of the invention include: detecting the tempos of the first and second music pieces each including a plurality of parts, and gradually changing the tempo of the drum sound part (first part) of the second music piece; and synchronizing the tempos of the drum sound parts of the first and second music pieces at the mixing start time or at the time after an elapse of a predetermined time from the mixing start time. Thus, each of the plurality of parts of the music piece is switched through a process in accordance with the characteristics of each part. Accordingly, a suitable switching operation during a mixing process for switching music pieces can be performed without making uncomfortable and unpleasant impression on a user.

Further, according to the first exemplary embodiment of the invention, the process for gradually shifting the tempo of the drum sound part of the second music piece to the original tempo is performed after synchronizing the tempos of the drum sound parts of the first and second music pieces. Thus, the tempo of the drum sound part of the second music piece, which has been changed for synchronization, can be restored to the original.

Further, according to the first exemplary embodiment of the invention, the process for aligning the playback positions of the drum sound part (first part) and the non-drum sound part (second part) of the second music piece is performed after gradually shifting the tempo of the drum sound part of the second music piece to the original tempo of the second music piece. Accordingly, the gap caused by changing the tempo of the drum sound part can be eliminated.

In addition, according to the first exemplary embodiment of the invention, in the predetermined section including the mixing start time or the point after an elapse of a predetermined time from the mixing start time, the non-drum sound part included in the first music piece is played at the original tempo of the first music piece and the non-drum sound part included in the second music piece is played at the original tempo of the second music piece, and concurrently, the non-drum sound part of the first music piece is switched to the non-drum sound part of the second music piece. Accordingly, the part whose divergence between the original and the playback sound results in uncomfortable and unpleasant impression on a user can be suitably switched without changing the tempo in accordance with the characteristics of the part.

Further, according to the first exemplary embodiment of the invention, the first part is a part of the drum sound part at least corresponding to the bass drum sound. Accordingly, the drum sound parts (especially the bass drum parts) of the music pieces, which possibly make uncomfortable and unpleasant impression on a user, can be switched in accordance with the characteristics of the parts.

### Second Exemplary Embodiment

A second exemplary embodiment will be described below, where components different from those of the first exemplary embodiment will be solely described, omitting the description for the same components as those of the first exemplary embodiment.

An acoustic device according to the second exemplary embodiment is configured substantially in the same manner as the acoustic device of the first exemplary embodiment. The acoustic device according to the second exemplary embodiment is different from the acoustic device of the first exemplary embodiment in the switching process of the drum sound parts of the first and second music pieces.

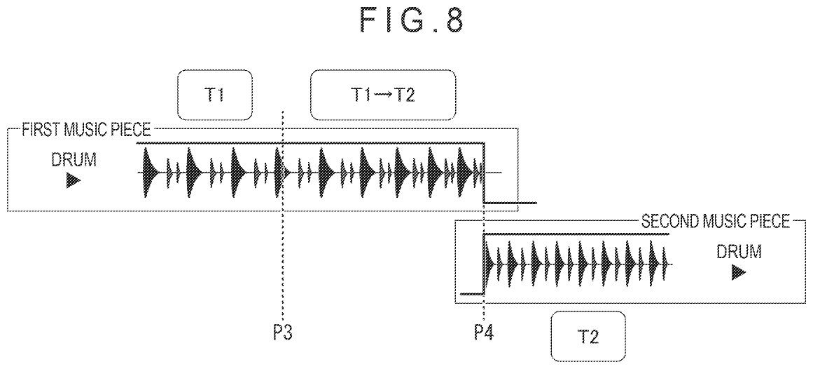

FIG. 8, which corresponds to FIG. 4 showing the first exemplary embodiment, is an illustration schematically showing a switching process of the music pieces (especially, the drum sound parts) by the acoustic device according to the second exemplary embodiment.

The acoustic device of the second exemplary embodiment performs a mixing process of the drum sound parts through the following steps (1) and (2) as shown in FIG. 8.
(1) During a period from a first time point P3 to a second time point P4, the tempo of the drum sound part of the first music piece is gradually changed from the tempo T1 (the original tempo of the first music piece) to the tempo T2.
(2) At the second time point P4, the first music piece is made to cut out and the second music piece is made to cut in.

As in the first exemplary embodiment, the process including the steps (1) and (2) is for switching the music pieces in accordance with the characteristics of the drum sound part while restraining uncomfortable and unpleasant impression caused at the time of the mixing operation. It should however be noted that, in the second exemplary embodiment, the tempo of the first music piece is adjusted instead of adjusting the tempo of the second music piece, as described above. In other words, the tempo of the drum sound part of the first music piece is adjusted during the period from the first time point P3 to the second time point P4, so that the tempos of the drum sound parts of the first and second music pieces are aligned at the second time point P4 for performing cut-out and cut-in. Accordingly, it is not necessary to adjust the tempo of the drum sound part of the second music piece as in the first exemplary embodiment.

Further, there is a gap in tempo and the playback positions between the drum sound part and the non-drum sound part of the first music piece during the period from the first time point P3 to the second time point P4 in the second exemplary embodiment. However, the non-drum sound part, which is being faded out, has a sound volume smaller than that of the drum sound part, and further has a rhythm less noticeable as long as the drum sound part (main part for beating the rhythm) is stably played. Thus, the non-drum sound part is less affected by the above-described gap.

In addition, the tempos of both of the drum sound part and the non-drum sound part of the second music piece are not adjusted in the second exemplary embodiment. Accordingly, since the playback positions of the drum sound part and the non-drum sound part of the second music piece are aligned at the second time point P4, calculation and process for aligning the playback positions of the drum sound part and the non-drum sound part of the second music piece are not necessary unlike the first exemplary embodiment. It should be noted that, as in the drum sound part of the second music piece of the first exemplary embodiment, the changed tempo of the drum sound part of the first music piece is optionally returned to the tempo T1 (the original tempo of the first music piece).

As described above, when the automatic mixing process is started, the tempo of the drum sound part of the first music piece is changed at the first time point P3 and the tempo of the first music piece is aligned with the tempo T2 (the original tempo of the second music piece) at the second time point P4, where the music pieces are switched by cut-out and cut-in. In contrast, the non-drum sound parts of the music pieces are switched by fade-out and fade-in without changing the tempos of the music pieces as in the first exemplary embodiment.

In order to perform the steps of (1) and (2) in the second exemplary embodiment, the setting of the automatic mixing process is determined as in the flowchart illustrated in FIG. 6 of the first exemplary embodiment. However, in the second exemplary embodiment, since it is not necessary to calculate the point for aligning the playback positions of the plurality of parts in Step S103, the process in Step S103 is unnecessary. Further, in the second exemplary embodiment, details for changing the tempo of the drum sound part of the first music piece from the tempo T1 (i.e., the original tempo of the first music piece) to the tempo T2 (i.e., the original tempo of the second music piece) are determined for the process in Step S104.

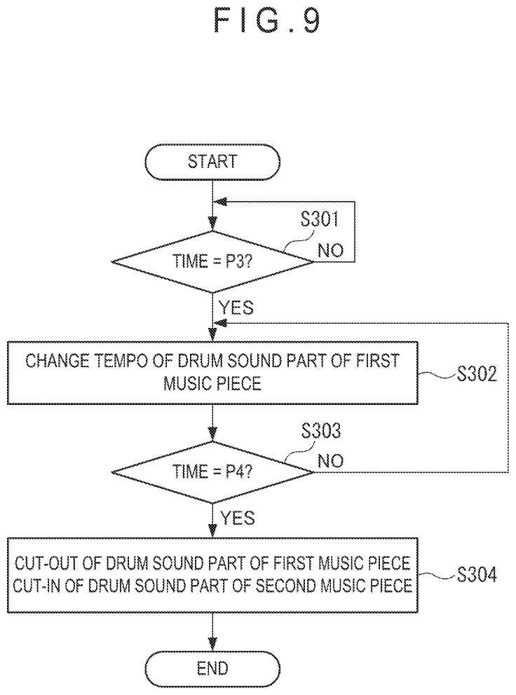

Next, a control method of the acoustic device in performing the automatic mixing process according to the second exemplary embodiment of the invention will be described below with reference to a flowchart illustrated in FIG. 9. It should be noted that the switching process for the drum sound parts of the music pieces will only be described in the example in FIG. 9 and the description of the switching process for the non-drum sound parts of the music pieces, which is the same as that of the first exemplary embodiment, will be omitted herein.

At the first time point P3 for the change in tempo of the drum sound part of the first music piece to be started (Step S301: YES), the first playback unit 64 gradually changes the tempo of the drum sound part of the first music piece from the tempo T1 to the tempo T2 in accordance with the control value calculated by the automatic mixing setting unit 62 (Step S302).

At the second time point P4 for the drum sound parts of the first and second music pieces to be made to cut out (Step S303: YES), the drum sound part of the first music piece is made to cut out by the first playback unit 64 in accordance with the control value calculated by the automatic mixing setting unit 62, while the drum sound part of the second music piece is made to cut in without changing the tempo by the second playback unit 65 in accordance with the control value calculated by the automatic mixing setting unit 62 (Step S304).

The processes performed in the above-described second exemplary embodiment of the invention include: detecting the tempos of the first and second music pieces each including a plurality of parts, and gradually changing the tempo of the drum sound part (first part) of the first music piece; and synchronizing the tempos of the drum sound parts of the first and second music pieces at the mixing start time or at the time after an elapse of a predetermined time from the mixing start time.

Accordingly, the same advantages as those of the first exemplary embodiment can be achieved. Especially, according to the second exemplary embodiment, since the process for aligning the playback positions of the drum sound part and the non-drum sound part of the second music piece is unnecessary, reduction in processing load is expectable.

### Third Exemplary Embodiment

A third exemplary embodiment will be described below, where components different from those of the first and second exemplary embodiments will be solely described, omitting the description for the same components as those of the first and second exemplary embodiments.

An acoustic device according to the third exemplary embodiment is configured substantially in the same manner as the acoustic device of the first and second exemplary embodiments. The acoustic device according to the third exemplary embodiment is different from the acoustic devices of the first and second exemplary embodiments in the switching process of the drum sound parts of the first and second music pieces.

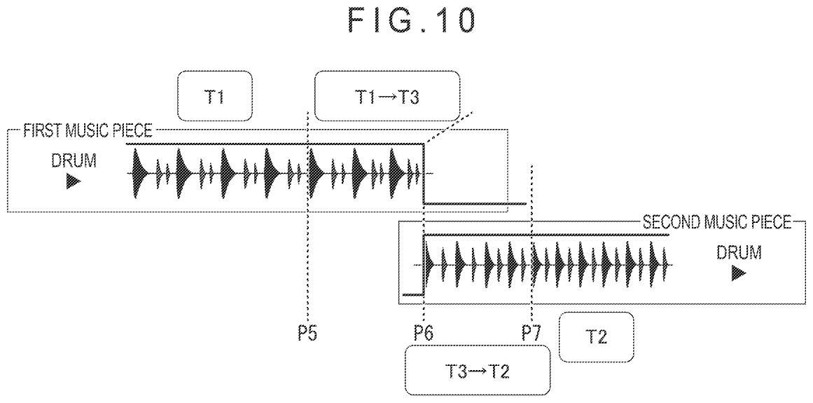

FIG. 10, which corresponds to FIG. 4 showing the first exemplary embodiment, is an illustration schematically showing a switching process of the music pieces (especially, the drum sound parts) by the acoustic device according to the third exemplary embodiment.

The acoustic device of the third exemplary embodiment performs a mixing process of the drum sound parts through the following steps (1) to (4) as shown in FIG. 10.
(1) During a period from a first time point P5 to a second time point P6, the tempo of the drum sound part of the first music piece is gradually changed from the tempo T1 (the original tempo of the first music piece) to the tempo T3.
(2) At the second time point P6, the first music piece is made to cut out and the second music piece is made to cut in.
(3) During a period from the second time point P6 to a third time point P7, the tempo of the drum sound part of the second music piece is gradually changed from the tempo T3 to the tempo T2 (the original tempo of the second music piece).
(4) At the third time point P7, the playback positions of the drum sound part and the non-drum sound part of the second music piece are aligned.

It should be noted that the tempo T3 in the steps (1) and (3) is, for instance, an intermediate tempo between the tempo T1 of the first music piece and the tempo T2 of the second music piece. The tempo T3 is optionally calculated based on a difference between the tempo T1 of the first music piece and the tempo T2 of the second music piece or, alternatively, is set as a predetermined constant tempo (e.g. constant BPM of 120).

As in the first and second exemplary embodiments, the process including the steps (1) to (4) is for switching the music pieces in accordance with the characteristics of the drum sound part while restraining uncomfortable and unpleasant impression caused at the time of the mixing operation. It should however be noted that, in the third exemplary embodiment, the tempo of the first music piece is also adjusted in addition to the tempo of the second music piece, as described above. In other words, in the third exemplary embodiment, while the tempo of the second music piece is changed to be close to the tempo T1 (the original tempo of the first music piece) as in the first exemplary embodiment, the tempo of the first music piece is changed to be close to the tempo T2 (the original tempo of the second music piece) as in the second exemplary embodiment. Accordingly, it is expectable that the gaps in the tempos and the playback positions between the drum sound part and the non-drum sound part of the first and second music pieces become smaller than those in the first exemplary embodiment.

As described above, when the automatic mixing process is started, the tempo of the drum sound part of the first music piece is changed from the first time point P5 to synchronize the tempos of the drum sound parts of the first and second music pieces at the second time point P6, where the music pieces are switched by cut-out and cut-in. Then, the tempo of the drum sound part of the second music piece is changed from the second time point P6. In contrast, the non-drum sound parts of the music pieces are switched by fade-out and fade-in without changing the tempos of the music pieces as in the first and second exemplary embodiments. Then, at the third time point P7, the playback positions of the drum sound part and the non-drum sound part of the second music piece are aligned.

In order to perform the steps of (1) to (4) in the third exemplary embodiment, the setting of the automatic mixing process is determined as in the flowchart illustrated in FIG. 6 of the first exemplary embodiment. It should be noted that details for changing the tempo of the drum sound part of the first music piece from the tempo T1 (the original tempo of the first music piece) to the tempo T3 and for changing the tempo of the drum sound part of the second music piece from the tempo T3 to the tempo T2 (the original tempo of the second music piece) are determined in Step S104.

It should also be noted that, as in the drum sound part of the second music piece, the changed tempo of the drum sound part of the first music piece is optionally returned to the tempo T1 (the original tempo of the first music piece).

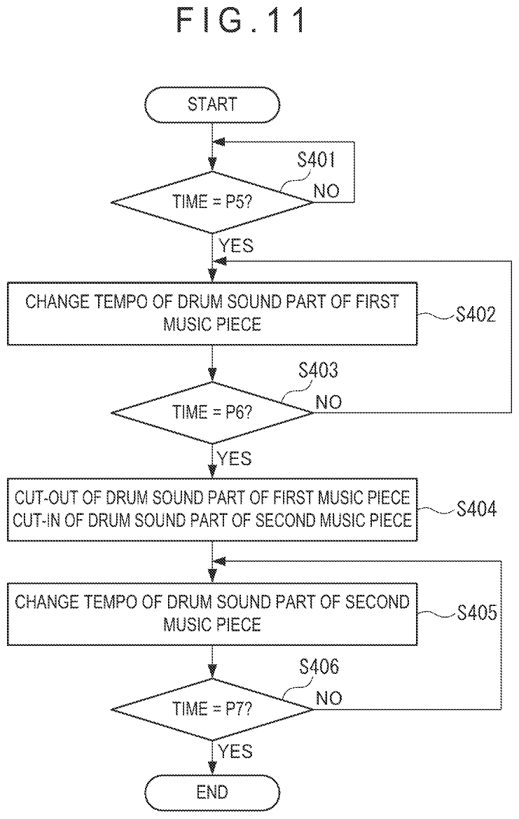

Next, a control method of the acoustic device in performing the automatic mixing process according to the third exemplary embodiment of the invention will be described below with reference to a flowchart shown in FIG. 11. It should be noted that, as in the second exemplary embodiment, the switching process for the drum sound parts of the music pieces will only be described in the example in FIG. 11 and the description of the switching process of the non-drum sound parts of the music pieces, which is the same as the first and second exemplary embodiments, will be omitted herein.

At the first time point P5 for the change in tempo of the drum sound part of the first music piece to be started (Step S401: YES), the first playback unit 64 gradually changes the tempo of the drum sound part of the first music piece from the tempo T1 to the tempo T3 in accordance with the control value calculated by the automatic mixing setting unit 62 (Step S402).

At the second time point P6 for the drum sound parts of the first and second music pieces to be respectively made to cut out and cut in (Step $403: YES), the drum sound part of the first music piece is made to cut out by the first playback unit 64 in accordance with the control value calculated by the automatic mixing setting unit 62, while the drum sound part of the second music piece is made to cut in in synchronization with the tempo T3 of the drum sound part of the first music piece by the second playback unit 65 in accordance with the control value calculated by the automatic mixing setting unit 62 (Step S404). Subsequently, the second playback unit 65 gradually changes the tempo of the drum sound part of the second music piece from the tempo T3 to the tempo T2 in accordance with the control value calculated by the automatic mixing setting unit 62 (Step S405).

Then, the second playback unit 65 continues the process of Step S405 until the third time point P7, where the playback positions of the drum sound part and the non-drum sound part of the second music piece are aligned (Step S406: YES).

The processes performed in the above-described third exemplary embodiment of the invention include: detecting the tempos of the first and second music pieces each including a plurality of parts, and gradually changing the tempo of the drum sound part (first part) of the first and the second music pieces; and synchronizing the tempos of the drum sound parts of the first and second music pieces at the mixing start time or at the time after an elapse of a predetermined time from the mixing start time. Accordingly, the same advantages as those of the first exemplary embodiment can be achieved.

It should be noted that a part of the processes described in the above-described exemplary embodiments is optionally omitted. For instance, after the process for synchronizing the tempos of the drum sound parts of the first and second music pieces is solely performed, one or both of subsequent processes of gradually shifting the tempo of the drum sound part of the first or second music piece toward the original tempo, and aligning the playback positions of the drum sound part and the non-drum sound part of the first or second music piece are optionally omitted.

Further, the tempos of the drum sound parts of the first and second music pieces in the above exemplary embodiments are not necessarily completely synchronized. For instance, for the purpose of applying sense of groove and accentuation, the BPM and beat position of the drum sound parts of the first and second music pieces are optionally intentionally deviated in a small measure when being synchronized.

Further, when the tempos of the drum sound parts of the first and second music pieces are to be synchronized in the above exemplary embodiments, the synchronization process is optionally ended before the mixing start time.

In addition, the plurality of parts of the first and the second music pieces, which are exemplified by two parts (i.e. the drum sound part and the non-drum sound part) in the above exemplary embodiments, are merely exemplary and are not limited to this example. The same process is applicable to a part(s) other than the above-mentioned two parts (e.g. vocal part, guitar sound part, bass guitar part, piano sound part) as long as such part(s) is involved with the performance of the first and second music pieces.

Further, though an entirety of the music pieces is switched in the automatic mixing process in the above exemplary embodiments, the scope of the invention is not limited to such an example. For instance, the music pieces are optionally switched using an operator such as the cross fader 314. In this case, the mixing start time is optionally defined at a time for starting the movement of the cross fader 314 from one end toward the other end thereof. Further, a part of the plurality of parts of the first and second music pieces (e.g. the drum sound part) is optionally subjected to the automatic mixing process described in the above exemplary embodiments and the non-drum sound parts of the music pieces are optionally switched using an operator such as the cross fader 314.

Further, the invention is not limited to an operator such as the cross fader 314 but is also applicable to an operator provided by software in a form of GUI (Graphical User Interface) or the like.

The acoustic device with the above functions is not necessarily configured as the DJ system described in the above exemplary embodiments but is optionally provided in a form of, for instance, a mixer and a DJ controller with a mixer function in some embodiments. Further, the invention is also applicable to DJ application software and music application software run on a computer, smartphone, and tablet terminal, streaming service using the Internet, and the like.

A 2-channel acoustic device including two media players 2A and 2B is described in the above example. However, for instance, a 4-channel acoustic device can also achieve the same functions. In addition, the invention is applicable not only to a DJ instrument but also to a typical mixer, electronic music instrument, and acoustic device such as DAW (Digital Audio Workstation) and DTM (Desk Top Music).

Suitable exemplary embodiments of the invention have been detailed above with reference to the attached drawings. However, the scope of the invention is not limited to the exemplary embodiments. It would be obvious for those skilled in the art to which the invention pertains that various modifications and revisions are conceivable within the technical idea described within claims, and it is understood that such modifications and revisions are naturally within the technical scope of the invention.

### EXPLANATION OF CODES

1 . . . acoustic device, 2A, 2B . . . media player, 3 . . . mixer, 4 . . . display unit, 5 . . . music data storage, 6 . . . control unit, 7 . . . audio output unit, 21A, 21B, 31 . . . operation unit, 41 . . . touch panel, 61 . . . receiver unit, 62 . . . automatic mixing setting unit, 63 . . . tempo detector, 64 . . . first playback unit, 65 . . . second playback unit, 211A, 211B . . . jog dial, 212A, 212B . . . tempo slider, 213A, 213B . . . cue button, 214A, 214B . . . play/pause button, 215A, 215B . . . performance pad, 311A, 311B . . . effect selector knob, 312A, 312B . . . effect amount adjuster knob, 313A, 313B . . . channel fader, 314 . . . cross fader

1. An acoustic device for mixing at least two music pieces comprising a first music piece and a second music piece, the acoustic device comprising:
a detector configured to detect a tempo of the first music piece and a tempo of the second music piece, the first and second music pieces each comprising a plurality of parts comprising a first part; and
a playback controller configured to gradually change a tempo of the first part of the first music piece or the second music piece and synchronize the tempo of the first part of the first music piece and the tempo of the first part of the second music piece at a mixing start time or after an elapse of a predetermined time from the mixing start time.

2. An acoustic device for mixing at least two music pieces comprising a first music piece and a second music piece, the acoustic device comprising:
a detector configured to detect a tempo of the first music piece and a tempo of the second music piece, the first and second music pieces each comprising a plurality of parts comprising a first part; and
a playback controller configured to gradually change a tempo of the first part of the first music piece and a tempo of the first part of the second music piece and synchronize the tempo of the first part of the first music piece and the tempo of the first part of the second music piece at a mixing start time or after an elapse of a predetermined time from the mixing start time.

3. The acoustic device according to claim 1, wherein the playback controller is configured to gradually shift the tempo of the first part of the first music piece or the second music piece to an original tempo thereof after synchronizing the tempos of the respective first parts of the first and second music pieces.

4. The acoustic device according to claim 1, wherein the playback controller is configured to align a playback position of the first part of the first music piece or the second music piece with a playback position of a second part different from the first part of the first music piece or the second music piece after gradually shifting the tempo of the first part of the first music piece or the second music piece to an original tempo thereof.

5. The acoustic device according to claim 1, further comprising a cross fader, wherein
the playback controller is configured to determine a time when the cross fader starts moving from one end toward the other end thereof as the mixing start time.

6. The acoustic device according to claim 1, wherein in a predetermined section comprising the mixing start time or a point after an elapse of a predetermined time from the mixing start time, the playback controller is configured to play a second part of the first music piece at an original tempo of the first music piece, play a second part of the second music piece at an original tempo of the second music piece, and switch the second part of the first music piece to the second part of the second music piece.

7. The acoustic device according to claim 1, wherein the first part is a part at least corresponding to a bass drum sound of a drum sound.

8. A control method of an acoustic device for mixing at least two music pieces comprising a first music piece and a second music piece, the method comprising:
detecting a tempo of the first music piece and a tempo of the second music piece, the first and second music pieces each comprising a plurality of parts comprising a first part;
gradually changing a tempo of the first part of the first music piece or the second music piece; and
synchronizing the tempo of the first part of the first music piece and the tempo of the first part of the second music piece at a mixing start time or after an elapse of a predetermined time from the mixing start time.

9. A control method of an acoustic device for mixing at least two music pieces comprising a first music piece and a second music piece, the method comprising:
detecting a tempo of the first music piece and a tempo of the second music piece, the first and second music pieces each comprising a plurality of parts comprising a first part;
gradually changing a tempo of the first part of the first music piece and the tempo of the first part of the second music piece; and
synchronizing the tempo of the first part of the first music piece and the tempo of the first part of the second music piece at a mixing start time or after an elapse of a predetermined time from the mixing start time.

10. A non-transitory computer-readable recording medium storing a program causing a computer to operate as an acoustic device for mixing at least two music pieces comprising a first music piece and a second music piece, the acoustic device comprising:
a detector configured to detect a tempo of the first music piece and a tempo of the second music piece, the first and second music pieces each comprising a plurality of parts comprising a first part; and
a playback controller configured to gradually change a tempo of the first part of the first music piece or the second music piece and synchronize the tempo of the first part of the first music piece and the tempo of the first part of the second music piece at a mixing start time or after an elapse of a predetermined time from the mixing start time.

11. A non-transitory computer-readable recording medium storing a program causing a computer to operate as an acoustic device for mixing at least two music pieces comprising a first music piece and a second music piece, the acoustic device comprising:
a detector configured to detect a tempo of the first music piece and a tempo of the second music piece, the first and second music pieces each comprising a plurality of parts comprising a first part; and
a playback controller configured to gradually change a tempo of the first part of the first music piece and a tempo of the first part of the second music piece and synchronize the tempo of the first part of the first music piece and the tempo of the first part of the second music piece at a mixing start time or after an elapse of a predetermined time from the mixing start time.

12. The acoustic device according to claim 2, wherein the playback controller is configured to gradually shift the tempo of the first part of the first music piece or the second music piece to an original tempo thereof after synchronizing the tempos of the respective first parts of the first and second music pieces.

13. The acoustic device according to claim 2, wherein the playback controller is configured to align a playback position of the first part of the first music piece or the second music piece with a playback position of a second part different from the first part of the first music piece or the second music piece after gradually shifting the tempo of the first part of the first music piece or the second music piece to an original tempo thereof.

14. The acoustic device according to claim 2, further comprising a cross fader, wherein
the playback controller is configured to determine a time when the cross fader starts moving from one end toward the other end thereof as the mixing start time.

15. The acoustic device according to claim 2, wherein in a predetermined section comprising the mixing start time or a point after an elapse of a predetermined time from the mixing start time, the playback controller is configured to play a second part of the first music piece at an original tempo of the first music piece, play a second part of the second music piece at an original tempo of the second music piece, and switch the second part of the first music piece to the second part of the second music piece.

16. The acoustic device according to claim 2, wherein the first part is a part at least corresponding to a bass drum sound of a drum sound.
